(19) United States
(12) Patent Application Publication
(10) Pub. No.: US 2005/0205706 A1
(43) Pub. Date: Sep. 22, 2005

(54) Bale processor with pre-disintegrator roller

(75) Inventor: Charles Lepage, Saskatoon (CA)

Correspondence Address: MICHAEL BEST & FRIEDRICH, LLP, 100 E WISCONSIN AVENUE, MILWAUKEE, WI, 53202, US

(73) Assignee: Highline Mfg. Inc., Vonda (CA)

(21) Appl. No.: 11/080,950

(22) Filed: Mar. 15, 2005

(30) Foreign Application Priority Data
Mar. 16, 2004 (CA) 2458874

(51) Int. Cl. B02C 19/12

(52) U.S. Cl. 241/605

(57) ABSTRACT

A bale processor is provided with a bale support that is arranged to promote maintenance of the weight of a bale on a pre-disintegrator roller during operation. Partial pre-disintegration of the bale by the pre-disintegrator roller may then be accomplished before the bale is processed by a flail roller. The pre-disintegrator roller may have teeth designed to improve the partial pre-disintegration as well as teeth adapted to move the bale forward or rearward within the bale processor depending upon the direction of rotation of said pre-disintegration member.

### FIELD OF THE INVENTION

The present invention relates to farm machinery for shredding bales and, more particularly, to a bale processor employing a pre-disintegrator roller.

### BACKGROUND

In the livestock industry, large round and square bales are often shredded using bale processors to feed and bed livestock. One type of bale processor currently in the market includes a roller longitudinally mounted for rotation inside a processing chamber. The roller is rotated and bale engaging members, typically flails, on the roller extend to engage a bale supported above the roller in the processing chamber, shred the baled material and discharge the shredded material out of the processor. The processors include bale manipulators for manipulating the bale within the processing chamber to expose different portions of the bale to the flails. The bale manipulators are typically driven by hydraulic motors that allow the user to change the speed and direction of rotation of the manipulators. Applicant's U.S. Pat. No. 5,340,040, issued Aug. 23, 1994 to Bussiere et al, discloses an early bale processor of the type described. Two bale manipulators are mounted parallel to the roller, above, and generally symmetrically to either side of the roller and are each driven by a dedicated hydraulic motor. In operation, a bale is supported and rotated by the manipulators. Flail guard rods are mounted above the roller such that the flails extend between the guard rods to engage the bales. When the bale processor is in operation, the guard rods prevent large portions of the bale from dropping between the manipulators onto the roller and hold the bale at a specified height above the flail drum regardless of the reduction in size of the bale.

In Applicant's Canadian Patent 2,390,985, an improved bale processor of the type discussed in the preceding paragraph is disclosed that utilizes only one driven manipulator. A bale to be processed is supported above the flail roller between the manipulator and a passive support, such as a passive roller or a baffle.

### SUMMARY

The present application relates to further improvements to such bale processors. Specifically, the positioning of the passive support is selected to try to maximize the extent to which the bale is supported on a pre-disintegrator roller when a bale is being processed. The pre-disintegrator roller functions to separate the baled crop material from the bale in addition to manipulating the bale for engagement of different parts by bale engaging members on a roller rotatable in the processing chamber. By promoting increased forces between the bale and the pre-disintegrator roller, the ability of the pre-disintegrator roller to assist in separating the baled crop material from the bale is enhanced.

In order to further enhance the ability of the pre-disintegrator roller to separate baled crop material, separating teeth are added to the pre-disintegrator roller facilitating aggressive engagement and separation of the bale by the teeth. Further, in order to enhance the efficiency of the bale processor, transverse teeth are included on the pre-disintegrator roller to urge the bale forward during processing which has been found to be advantageous for processing, including by avoiding materials spilling out the back of the processor during operation.

Accordingly, the present invention relates to improvements in using a single driven pre-disintegrator roller to perform separating/disintegrating and manipulating functions. Through appropriate placement of a passive bale support and use of appropriate bale engaging teeth on the pre-disintegrator roller, engagement between a bale being processed and the pre-disintegrator roller is increased and the pre-disintegrator roller effectively rotates the bale while assisting in the disintegration of the bale. Through appropriate configuration of the processing chamber, an effective flow of material separated from the bale being processed by the pre-disintegrator roller is provided for.

In accordance with a broad aspect of the present invention there is provided a bale processor comprising: a processing chamber; a roller with bale engaging members attached thereto, the roller being rotatably mounted in the processing chamber about a first longitudinal axis; a pre-disintegrator roller mounted for rotation about a second longitudinal axis above, and generally parallel to, the first longitudinal axis and to a first side of the roller; and a passive bale support mounted so as to define a plane extending away from the roller at an angle of greater than approximately 25 degrees to the horizontal from a lowest support point generally adjacent to the outer extension of the bale engaging members, the passive bale support being located to a second side of the roller such that a bale in the processing chamber is supported against downward movement on the second side of said roller substantially wholly by said passive bale support such that the bale is supported without a driven roller on the second side. The pre-disintegrator roller and the passive bale support facilitate maintenance of a bale above the roller for engagement of the bale by the roller between the pre-disintegrator roller and the passive bale support.

In accordance with another broad aspect of the present invention there is provided a bale processor including: a processing chamber; a roller with bale engaging members attached thereto, the roller being rotatably mounted in the processing chamber about a first longitudinal axis; a pre-disintegrator roller for rotation about a second longitudinal axis above, and generally parallel to, the first longitudinal axis and to a first side of the roller, the pre-disintegrator roller including a plurality of separating members and a plurality of manipulating members; guard rods mounted transverse to and spaced along the first longitudinal axis and mounted at a height above the roller to allow the bale engaging members to extend between and beyond the guard rods to engage a bale when the bale processor is in operation; and a passive bale support mounted so as to define a plane extending away from the roller at an angle of greater than approximately 25 degrees to the horizontal from a lowest support point generally adjacent to the outer extension of the bale engaging members and above the roller, the passive bale support being located to a second side of the roller such that a bale in the processing chamber is supported against downward movement on the second side of said roller substantially wholly by said passive bale support such that a bale is supported without a driven roller on the second side. The pre-disintegrator roller and the passive bale support facilitate maintenance of the bale above the roller for engagement of the bale by the roller between the pre-disintegrator roller and the passive bale support.

In accordance with a further broad aspect of the present invention there is provided a bale processor including: a processing chamber; a roller with bale engaging members attached thereto, the roller being rotatably mounted in the processing chamber about a first longitudinal axis; a pre-disintegrator roller for rotation about a second longitudinal axis above, and generally parallel to, the first longitudinal axis and to a first side of the roller, the pre-disintegrator roller including a plurality of separating members and a plurality of manipulating members; guard rods mounted transverse to and spaced along the first longitudinal axis and mounted at a height above the roller to allow the bale engaging members to extend between and beyond the guard rods to engage a bale when the bale processor is in operation; and a passive bale support mounted so as to define a plane extending away from the roller at an angle of greater than approximately 25 degrees to the horizontal from a lowest support point generally adjacent to the outer extension of the bale engaging members and above the roller, the passive bale support being located to a second side of the roller such that a bale in the processing chamber is supported against downward movement on the second side of said roller substantially wholly by said passive bale support such that the bale is supported without a driven roller on the second side. The pre-disintegrator roller and the passive bale support facilitate maintenance of the bale above the roller for engagement of the bale by the roller between the pre-disintegrator roller and the passive bale support and the processing chamber includes an extension member pivotally mounted between a front end wall of the processing chamber and a back end wall of the processing chamber to the second side of the roller, the active extension member being pivotable between an open position in which the active extension member extends along the plane of the passive bale support and a closed position in which the extension member overlays the roller.

Other aspects and features of the present invention will become apparent to those of ordinary skill in the art upon review of the following description by way of example of exemplary embodiments of the invention in conjunction with the accompanying figures.

### BRIEF DESCRIPTION OF THE DRAWINGS

In the figures:

FIG. 1 is a front perspective view of an embodiment of a bale processor according to the invention;

FIG. 2 is a rear view of the bale processor of FIG. 1 with the back wall removed;

FIG. 2A is an enlarged view of a portion of FIG. 2 showing the flail roller;

FIG. 3 is a perspective view of a pre-disintegrator roller according to an aspect of the present invention;

FIG. 4 is a side view of the pre-disintegrator roller of FIG. 3;

FIG. 5 is a side view of the pre-disintegrator roller of FIG. 3 rotated 90 degrees on its longitudinal axis relative to the view of FIG. 4;

FIG. 6 is an end view of the pre-disintegrator roller of FIG. 3;

FIG. 7 is a rear view of an embodiment of a bale processor according to the invention;

FIG. 8 is a rear view of the bale processor of FIG. 7 illustrating a position change in active processing chamber extension bars;

FIG. 9 is a front view of a bale processor according to the invention, illustrating a mounting arrangement for a power source for the pre-disintegrator roller;

FIG. 10 is a perspective view of a modified pre-disintegrator roller according to an aspect of the present invention;

FIG. 11 is a side view of the modified pre-disintegrator roller of FIG. 10;

FIG. 12 is a side view of the modified pre-disintegrator roller of FIG. 10 rotated 90 degrees on its longitudinal axis relative to the view of FIG. 11;

FIG. 13 is an end view of the modified pre-disintegrator roller of FIG. 10;

FIG. 14 is a rear view of an embodiment of the bale processor according to the invention including the movable passive support; and

FIGS. 15 and 16 are rear views of the bale processor of FIG. 14 illustrating different positions of the passive support.

### DETAILED DESCRIPTION

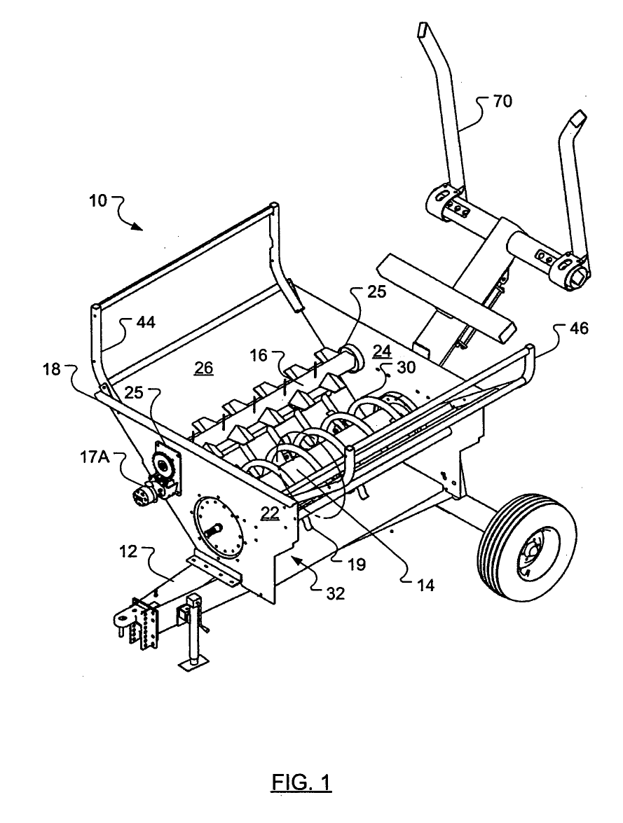

FIG. 1 illustrates an exemplary bale processor 10 showing one embodiment of the present invention. The bale processor 10 has a frame structure 12 that supports a processing chamber 18 having a front end wall 22, a back end wall 24 and a right side wall 26 (as viewed from the back of the processor looking in the direction of travel). The size of the processing chamber 18 is expanded through the use of extension bars or panels. The right side wall 26 is illustrated as being extended by extension bars 44 while the left side of the processor chamber is defined and extended by extension bars 46.

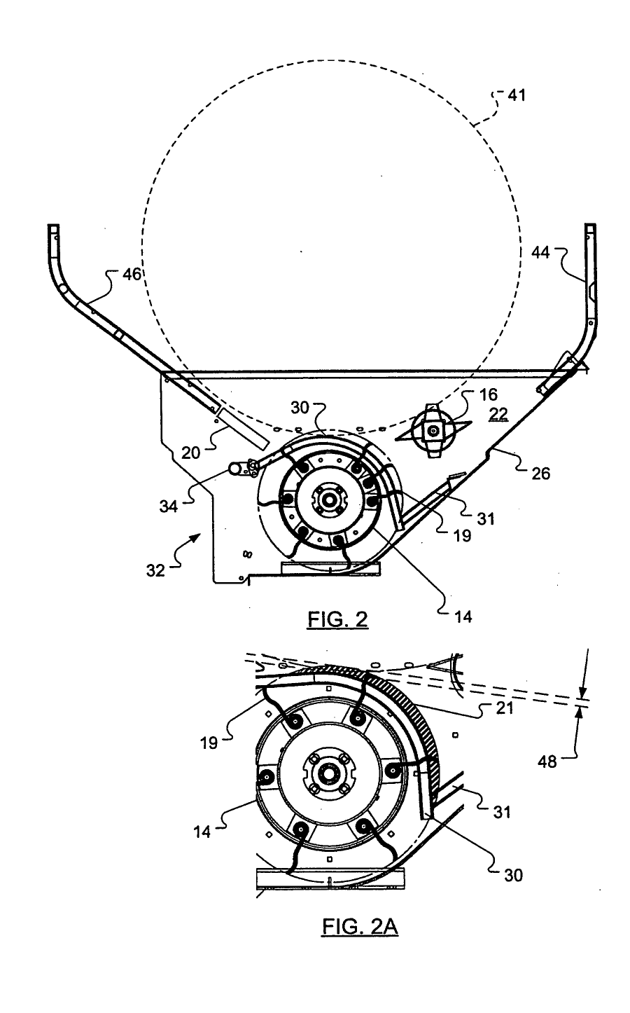

In the embodiment shown in FIG. 1, the left side of the processing chamber 18 includes a discharge opening 32 through which processed crop material may be discharged. A roller 14 is mounted between the front end wall 22 and the back end wall 24 for rotation about its longitudinal axis in the bottom of the processing chamber 18. The roller 14 has bale engaging members 19 for engaging crop material placed in the processing chamber and discharging processed crop material through the discharge opening 32. In the preferred embodiment illustrated in FIG. 1, the roller 14 is a flail roller having bale engaging members in the form of a plurality of flails 19 pivotally mounted thereon that extend under centrifugal force to engage material from a bale 41 (see FIG. 2) and discharge the shredded material out of the processor 10 when the processor is operated. However, as will be understood by those skilled in the art, other embodiments of the roller 14 may be used, including rollers using cutting knives, hammers or any other members fixed thereto and extending therefrom adapted to engage baled material in the processor and discharge the shredded material out of the processor 10 when the processor is operated.

The roller 14 is typically rotated by the power take-off (PTO) drive of a tractor. In the illustrated embodiment, the flail roller 14 is rotated in a clockwise direction (viewed from the back of the machine) and the flail roller 14 may be connected directly to the PTO drive of most tractors. If right hand discharge is desired, the roller 14 may be connected to the PTO drive through rotation conversion means such as known gear boxes, drive chain or pulley arrangements or generally any suitable means for converting an input rotation to an opposite output rotation. Alternatively, a different type of power source, such as a reversible hydraulic or electric motor, may be used to drive the flail roller 14. Typically, the roller 14 will be rotated at approximately 1000 rpm (the speed of the PTO drive of most tractors), although the roller 14 may be designed to be rotated at rates within the range of 500 to 2,000 rpm to accommodate variable speed of different PTO's and/or alternative power sources.

In a preferred embodiment, flail guard rods 30 are mounted within the processing chamber 18 above the flail roller 14. The flail guard rods 30 are axially spaced along the length of the processing chamber 18 such that, in operation, the flails 19 extend between the flail guard rods 30 to engage the bale 41 within the processing chamber 18. In the embodiment illustrated in FIG. 2, one end of each flail guard rod 30 is mounted to a mounting bar 34 connected between the front end wall 22 and the back end wall 24 of the processing chamber 18. The other end of each flail guard rod 30 forms an obtusely angled bend and is supported by the right side wall 26.

The flail roller 14 illustrated in FIG. 2 is shown in an enlarged view in FIG. 2A. The enlarged view illustrates the shape of a sweep 21 of the flail 19 beyond the flail guard rods 30. The sweep 21 is defined by a degree 48 of extension of the flails 19 beyond the flail guard rods 30, which is illustrated for the point at which the flails 19 engage the bale 41, that increases, peaks and decreases based on the shape of the flail guard rods 30. The shape of the sweep 21 promotes effective engagement of material, reduces backslap of the flails due to the counter force encountered upon engagement with the bale 41, and generally increases flail performance. Notably, the sweep 21 extends past the point at which each flail guard rod 30 forms an obtusely angled bend so that separated material that may otherwise accumulate at that point is cleared out by the flails.

The height of the flail guard rods 30 above the flail roller 14 may be adjusted to alter the degree 48 (see FIG. 2A) to which the flails 19 extend beyond the flail guard rods 30, thereby altering the rate at which the bale 41 is discharged from the processing chamber 18. Specifically, the height may be adjusted by movement of the location of the mounting bar 34 connecting the flail guard rods 30 to the front end wall 22 and the back end wall 24. This may be effected by providing a series of mounting locations on the front end wall 22 and the back end wall 24, and using a locking pin or other arrangement to retain the mounting bar 34 at the desired location. Alternatively, the height of the flail guard rods 30 may be altered by movement of the mounting bar 34 through a hydraulic or electric system of any suitable type known in the art. In a further embodiment, the flail guard rods 30 may be cantilevered from mounting bar 34 and have their height adjusted by rotation of the mounting bar 34.

As best shown in FIG. 1, embodiments of the invention include a pre-disintegrator roller 16 rotatably mounted in the processing chamber 18 on the front end wall 22 and back end wall 24 through suitable roller mounts 25 that support the roller 16 while permitting rotation thereof. The pre-disintegrator roller 16 is mounted above the flail roller 14 and toward the right side wall 26.

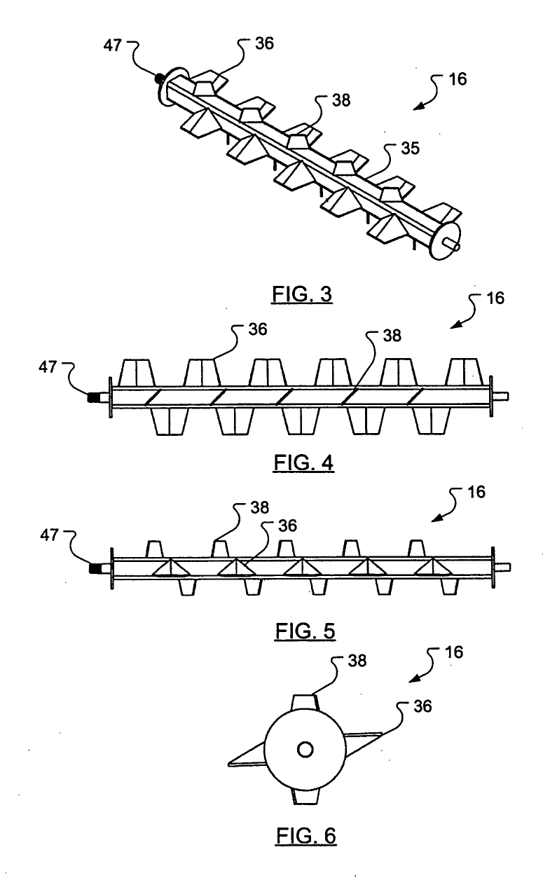

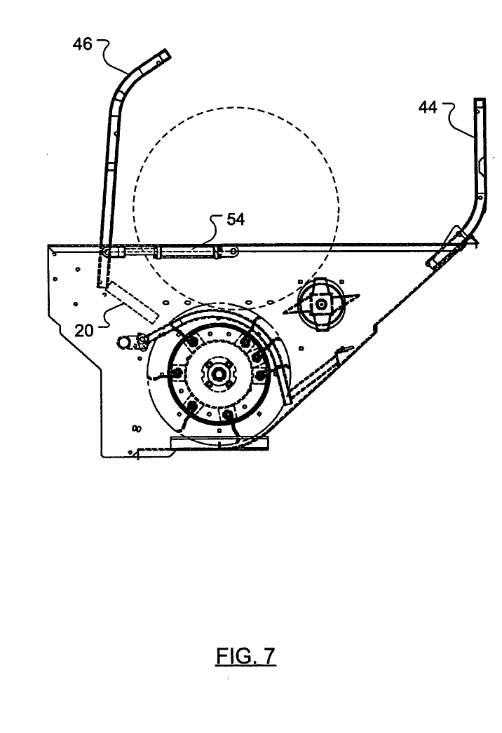

As shown in FIGS. 3-6, a preferred pre-disintegrator roller 16 includes an elongated member 35 having bale engaging members attached thereto in the form of a set of separating teeth 36 and a set of transverse teeth 38. The teeth 36, 38 are attached to and extend radially from the elongated member 35. A splined connection 47 extends axially from an end of the elongated member 35. The splined connection 47 is adapted for connection to a drive system 17A (see FIG. 1).

In the illustrated embodiment, each of the separating teeth 36 is formed as a plate-like element configured to flatten from a v-shaped base edge to a linear top edge. As such, each of the separating teeth 36 has a crease or spine. Additionally, in the illustrated embodiment, the sides of the separating teeth 36 taper inward from the base edge to the top edge. The v-shaped base edge is attached to the pre-disintegrator roller 16 such that the linear top edge is generally parallel to the longitudinal axis of the elongated member 35. Since the separating teeth 36 serve both to control rotation of the bale and to assist in disintegration of material from the bale, the width of the top edge is selected so as to be wide enough to effectively rotate the bale and narrow enough for effective disintegration (penetration and separation). Typically, the width of the top edge will be between 3 and 6 inches.

In the illustrated embodiment, the transverse teeth 38 are planar and trapezoidal in shape. The long side of the trapezoid is attached to the pre-disintegrator roller 16 such that the plane of the transverse teeth 38 forms an angle of approximately 45 degrees with the longitudinal axis of the pre-disintegrator roller 16. It will be appreciated by those skilled in the art that other shapes and angles may be used for the teeth 36, 38 although the shapes and angles illustrated have been found to be effective in the Applicant's processors.

The pre-disintegrator roller 16 is rotatable about its longitudinal axis, which is generally parallel to the longitudinal axis of the flail roller 14 and is designed such that, under influence of the teeth 36, 38, the bale 41 will move forward (i.e., toward the front end wall 22) when the pre-disintegration roller 16 is rotated clockwise (as seen from the rear of the machine (FIG. 2)).

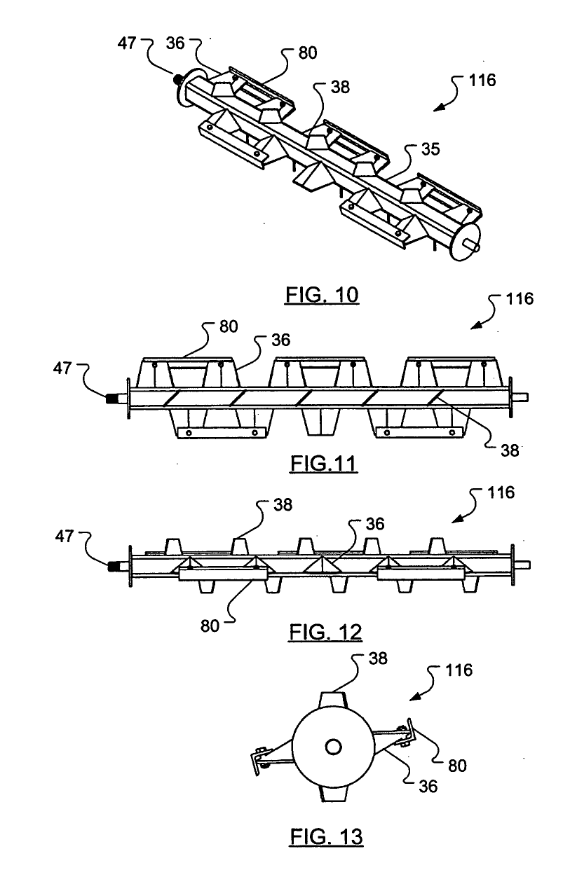

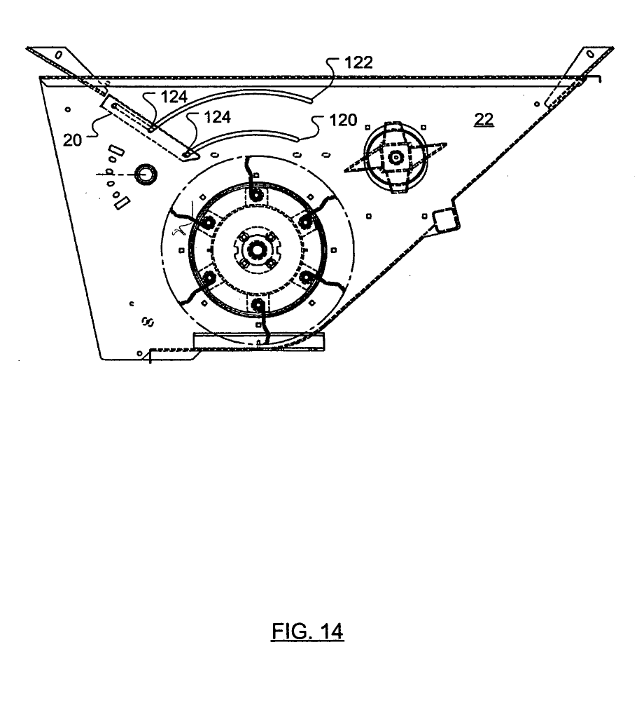

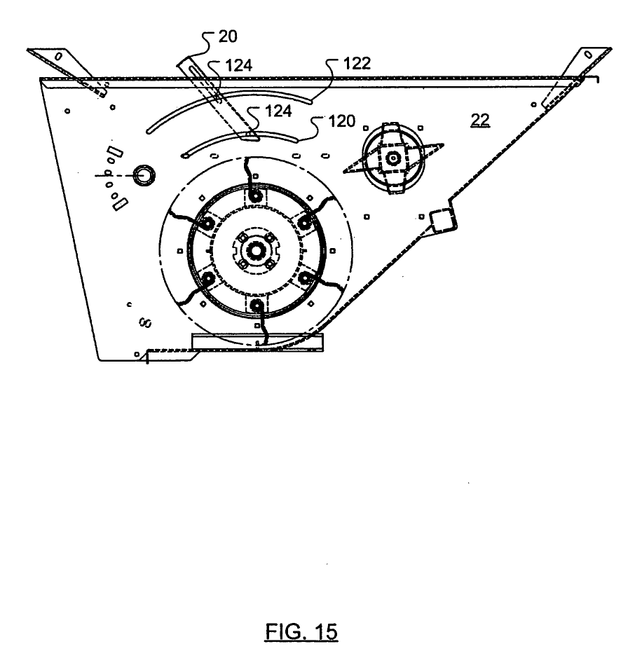

As shown in FIGS. 10-13, a modified pre-disintegrator roller 116 includes all of the same components as the pre-disintegration roller 16 of FIGS. 3-6. The modified pre-disintegrator roller 116 further includes a set of cross bars 80 connecting selected separating teeth 36. As illustrated in FIGS. 10-12, where an even number of separating teeth 36 are on a given side of the elongated member 35, the separating teeth 36 may be connected in pairs. Additionally, where an odd number of separating teeth 36 are on a given side of the elongated member 35, pairs of the separating teeth 36 may be connected, leaving a single, central separating tooth 36 unconnected. Advantageously, the arrangement illustrated in FIGS. 10-12 provides contact between the cross bars 80 and the bale being processed over the complete length of the elongated member 35 over the course of a complete rotation of the elongated member 35. Clearly, other arrangements, with their own inherent advantages, may be devised.

By installing the cross bars 80, which the applicant has implemented as appropriately sized lengths of material bolted to the separating teeth 36, the bale processor 10 as a whole is better adapted to process bales of short material, such as short straw. In particular, the cross bars 80 allow the modified pre-disintegrator roller 116 to more effectively rotate the bale to expose different portions of the bale to the flails 19. In the absence of the cross bars 80, the applicant has found that the pre-disintegrator roller 16 of FIGS. 3-6 may not appropriately rotate bales of short material. In addition, the cross bars 80 enhance the ability of a bale processor employing the modified pre-disintegration roller 116 to process loose material (i.e., material not in a bale).

In the embodiment illustrated in FIG. 1, the drive system 17A utilizes a reversible hydraulic motor mounted on the front end wall 22 as the power source for rotating the pre-disintegrator roller 16 about its longitudinal axis.

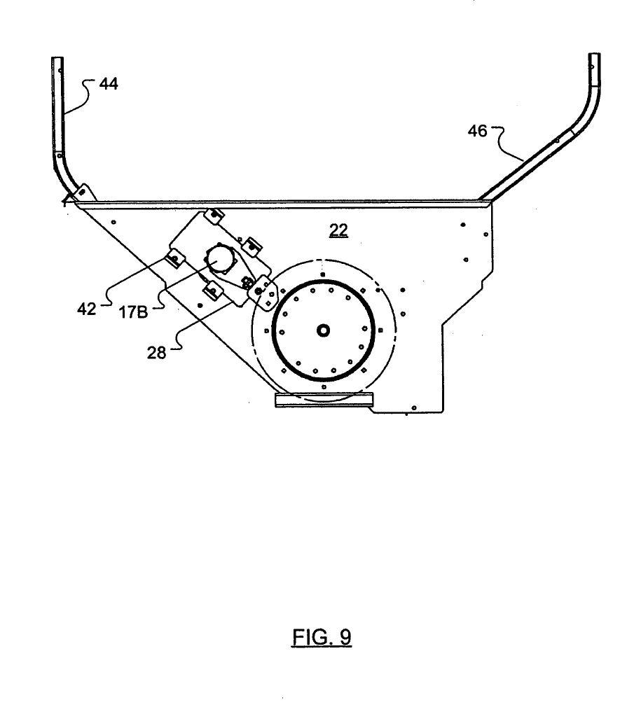

In an alternate embodiment, the pre-disintegrator roller 16 as well as an alternate drive system 17B may be mounted to the front end wall 22 and back end wall 24 through the use of an adjustable slide plate system. As illustrated in FIG. 9, retainer clips 42 retain a slidable mounting plate 28 on the front end wall 22. Suitable roller mount bearings (not shown) are mounted on the mounting plate 28, and a similar plate retained in a similar fashion on the back end wall 24, and extend through obround holes in the front end wall 22 and back end wall 24. In this embodiment, the pre-disintegrator roller 16 may move toward or away from the flail roller 14 to minimize disruption of processing due to roller blockage by ice chunks, etc., and to facilitate effective processing of different sizes and shapes of bales. As will be understood by those skilled in the art, the force required to move the roller may be adjustable through the application of different tension to the retainer clips 42, or the plate 28 may be free to slide under the effects of gravity and the forces generated by operation of the processor. Similarly, it will be understood by those skilled in the art that the position of the roller may be manually adjustable, or the illustrated mounting system could be replaced by a hydraulic or electric system facilitating ease of adjustment of the rest position of the pre-disintegrator roller 16 as well as the force required to move the pre-disintegrator roller 16 during operation of the processor 10.

Generally, in view of the various embodiments disclosed, the position of the pre-disintegrator roller 16 may be permanently fixed or may be adjustable between different fixed positions or may be free to move within a predefined range at all times.

Those skilled in the art will also understand that, while the illustrated embodiments show the use of a hydraulic motor as the drive system, other systems may be utilized including electric motors, gear and chain arrangements adapted for selective driving of the pre-disintegrator roller 16 from the same power source as the flail roller 14, etc. However, there are benefits to utilizing a drive system that allows for ease of adjustment of the speed of rotation of the pre-disintegrator roller 16 independent of the flail roller, as well as providing for reversing the direction of rotation when required. Accordingly, use of a separate hydraulic or electric motor is preferred by the Applicant.

In the embodiment shown in FIG. 2, a passive support 20 is mounted in the processing chamber 18 above and to the left-side of the flail roller as seen from the back of the bale processor 10. In the illustrated embodiment, the passive support 20 comprises a flat planar member mounted between the front end wall 22 and the back end wall 24 such that it is slanted inwardly and downwardly at an angle of approximately 35 degrees to the horizontal from an upper end toward the side of the processing chamber to a lower end generally adjacent to the outer extension of the flails 19 on the flail roller 14. The passive support 20 and extension bars 46 are arranged to support the bale 41 in the processing chamber 18 and, in operation, to assist in urging the bale 41 under gravity toward the pre-disintegrator roller 16.

Generally, angles of less than approximately 25 degrees for the passive support should be avoided since they allow loose separated material to accumulate on the passive support 20 or extension 46. The Applicant has found that an angle of 35 degrees to the horizontal is preferred for effectively shifting the weight of the bale 41 towards the pre-disintegrator roller 16 and avoiding accumulation of loose material.

It will be understood by a person skilled in the art that the planar member could be replaced with an alternative structure, such as one or more non-driven rollers or a grate with a series of rods parallel to the flail guard rods 30, without departing from the invention in its broadest aspect.

As discussed, in the embodiment of the invention illustrated in FIG. 2, extension bars 46 on the same side of the processor as the passive support 20 are utilized to expand the size of the processing chamber. The extension bars 46 are generally mounted between the front end wall 22 and the back end wall 24 immediately adjacent to and in line with the passive support 20. As will be understood by those skilled in the art, the extension bars 46 could be formed in a unitary fashion with the passive support 20. However, utilizing separate elements facilitates transport with the extension elements 46 folded inward or removed. However, when fully assembled, in the embodiment illustrated in FIG. 2, extension bars 46 are rigidly mounted to the front end wall 22 and the back end wall 24.

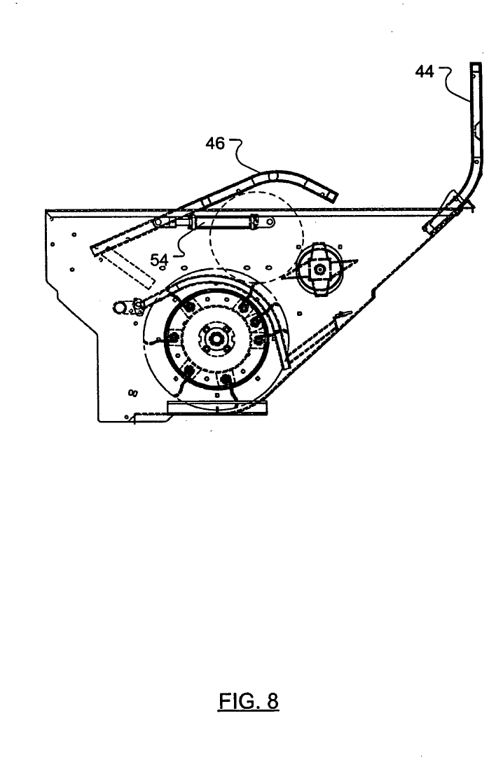

In an alternate embodiment as illustrated in FIGS. 7 and 8, extension bars 46 are pivotally connected to the front wall 22 and the back end wall 24. An extension bar actuator 54 is connected between the front end wall 32 of the processing chamber and the extension bars 46 and is adapted to be actuated to move the extension bars 46 between a position where the extension bars are generally aligned with the passive support member 20 (generally as shown in FIG. 2) to a position at an angle of less than 90° to the passive support 20 as shown in FIG. 8. The extension bar actuator 54 may be any suitable actuator including a manual lever, electric actuator or, as shown, a hydraulic cylinder.

Referring again to the embodiment shown in FIGS. 1 and 2, in operation, a bale 41 is loaded into the processing chamber 18 for disintegration normally using the bale loading fork 70 (see FIG. 1). Viewing the processor from the rear of the machine looking in the direction of travel (as per FIG. 2), the flail roller 14 and pre-disintegration roller 16 are rotated by their separate power sources in a clockwise direction. The flails 19 extend under centrifugal force and engage the bale 41. As the flails complete their rotation, separated baled crop material is thrown from the processor through the discharge opening 32. The bale 41 is caused to rotate in a counterclockwise direction. Due to the angle of the passive support 20 and the extension bars 46 and the effect of the forces applied by the flails 19 and the pre-disintegration roller 16, a significant portion of the weight of the bale 41 is supported by the pre-disintegration roller 16 and guard rods 30. As some of the weight of the bale is supported on the pre-disintegration roller 16, there is positive engagement of the bale 41 by the separating teeth 36 thereby promoting separation of baled crop material by the teeth 36. In fact, depending upon the composition and density of the bale, the pre-disintegration roller 16 may, in effect, peel off layers of the bale 41 and direct the material so separated from the bale 41 such that it flows between the pre-disintegration roller 16 and the right side wall 26. Due to the angle of the right side wall 26, material separated by the pre-disintegration roller 16 is then directed into the flail roller and discharged out of the opening 32. At the same time, the transverse teeth 38 on the pre-disintegration roller 16 tends to urge the bale toward the front wall 22 of the bale processor 10. Generally, the arrangement disclosed in FIG. 2, promotes consistent engagement of the bale 41 by both the flail roller 14 and the pre-disintegration roller 16 as the size of the bale 41 is reduced during processing, thereby enhancing the speed/efficiency and consistency of processing utilizing the bale processor of the invention.

Notably, through appropriate configuration of the processing chamber 18, effective flow of material separated from the bale 41 by the pre-disintegrator roller 16 may be provided for. In particular, the flow of material may be facilitated by leaving sufficient distance between the right side wall 26 and the pre-disintegrator roller 16, combined with the angle of the wall 26, all as illustrated in FIG. 2.

Although the flail roller 14 and pre-disintegration roller 16 are described hereinbefore as being rotated by their separate power sources in a clockwise direction, the applicant has discovered that, for some types of bales, rotating the pre-disintegration roller 16 in opposite directions can lead to more optimal disintegration of the bale.

During the typical operation of the bale processor 10 the flail roller 14 and the pre-disintegration roller 16 are rotated in the same direction. In the embodiment illustrated in FIG. 2, the flail roller 14 is rotated in a clockwise direction (viewed from the back of the machine). In typical operation of the bale processor 10, the pre-disintegration roller 16 is also rotated in a clockwise direction. As the pre-disintegration roller 16 is rotated, the separating teeth 36 on one side of the pre-disintegration roller 16 contact the bale 41 and tend to lift the bale 41. As the pre-disintegration roller 16 is rotated further, the linear edges of the separating teeth 36 penetrate the bale 41 as the bale is rotated. As the pre-disintegration roller 16 is rotated even further, the linear edges of the separating teeth 36 move away from the bale 41 and, due to the penetration of the previous step, tend to separate some material from the bale 41. As the separating teeth 36 loose contact with the bale upon further rotation of the pre-disintegration roller 16, the bale 41 will tend to fall back into close contact with the pre-disintegration roller 16 and, in particular, into close contact with the transverse teeth 38. Falling on the transverse teeth 38 urges the bale 41 forward within the processing chamber 18 (i.e., toward the front end wall 22) due to the angle of the transverse teeth 38 relative to the longitudinal axis of the pre-disintegrator roller 16. This forward motion during processing has been found to be advantageous for processing in that the spilling of material out the back of the processor during operation is avoided.

As noted, the pre-disintegration roller 16 may also be rotated in a direction opposite to the direction of rotation of the flail roller 14. In that case, as the pre-disintegration roller 16 is rotated, the linear edges of the separating teeth 36 of the pre-disintegration roller 16 contact the bale 41 and tend to penetrate it. As the pre-disintegration roller 16 is rotated further, the linear edges of the separating teeth 36 move away from the bale 41 and, due to the penetration of the previous step, tend to separate some material from the bale 41 and feed it to the flail roller 14 between the pre-disintegration roller 16 and the passive support 20. Upon continued rotation of the pre-disintegration roller 16, the bale 41 comes into contact with the transverse teeth 38. Since the bale 41 is not lifted by the separating teeth 36, the bale 41 does not fall on the transverse teeth 38, and the bale 41 is unlikely to be urged in a transverse direction within the processing chamber 18. Instead, the transverse teeth 38 tend to assist the disintegration of the bale 41. The direction of rotation of the bale 41 is influenced more by the pre-disintegration roller 16 than by the flail roller 14. When the pre-disintegration roller 16 is rotated counterclockwise, the bale 41 is accordingly rotated clockwise.

Problems may be encountered in processing baled crop material due to the density of different portions of a single bale varying, extraneous matter in the bale and frozen chunks of the bale that may result in inconsistent processing, damage to the flail roller 14 and the pre-disintegrator roller 16 in the bale processor and, in certain cases, blockages sufficient to delay further processing. Similarly, accumulation of separated material in the processing chamber may cause problems with consistency of processing and blockage of the bale processor. By maintaining weight on the pre-disintegrator roller 16 and flail guard rods 30 and as a result of the configuration of the chamber whereby the right-side wall 26 feed material passing behind the pre-disintegration roller 16 to flail roller 14, and the adjacent nature of the passive support 20 to the periphery of the flail rotation envelope as well as the proximity of the extension bars 46 to the passive support, blockages and inconsistent processing are minimized in bale processors according to the invention. Further, providing for a reversible pre-disintegration roller in bale processors having the basic geometry of the processors of the present invention assists in alleviating blockage due to ice chunks, etc. by allowing for reverse rotation to dislodge such blocking material.

In the alternate embodiment shown in FIGS. 7 and 8, activation of the extension bar actuator 54 may be utilized to promote consistent force of the bale 41 on the flail guard rods 30 and pre-disintegration roller 16. Use of the pre-disintegration roller mounting means as shown in FIG. 9 further minimizes problems due to extraneous matter or ice by allowing the pre-disintegration roller 16 to move relative to the flail roller 14 and right-side wall 26. This allows such matter to pass between the roller and the side-wall and down to the area where the material will be engaged by the flails without the full force of gravity due to the angle of the right-side-wall 26.

The flail guard rods 30 support the material being processed and minimize clogging of, and damage to, the flail roller 14 by material that has not been separated or disintegrated falling on the flail roller through the opening between the pre-disintegrator roller 16 and passive support means 20. In the exemplary embodiment illustrated in FIG. 2, adjustment of the mounting bar 34 may serve to alter the degree 48 to which the flails 19 extend beyond the flail guard rods 30 and accordingly to vary the rate of discharge by the flail roller 14.

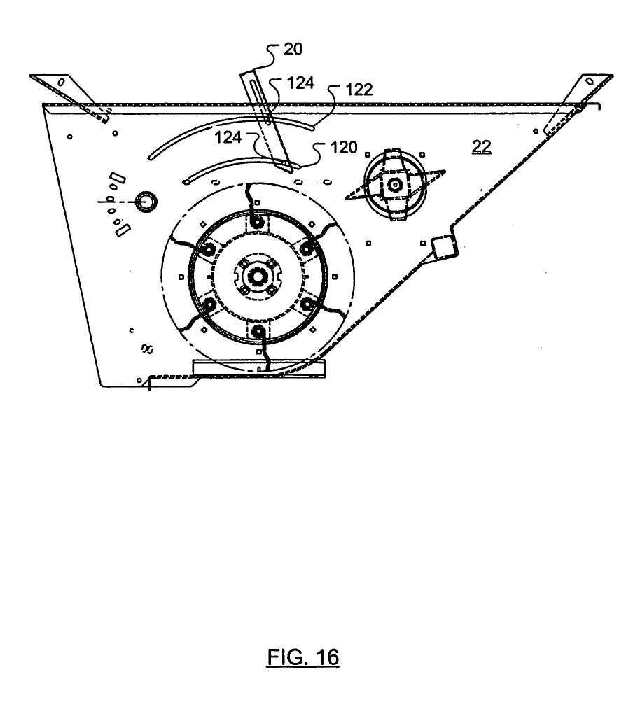

A further alternate embodiment of the bale processor according to the invention is shown in FIGS. 14-16. In that embodiment, the passive support 20 is slidingly mounted in the processor by fasteners 124 in slots 120, 122 in the front end wall 22 and in similar slots in the rear end wall 24. The position of the passive support 20 may be adjusted to suit the particular application for which the processor is to be used. The fasteners 124 are selected to have sufficient strength to support the passive support and to withstand forces applied to the passive support 20 by baled material in the processor. Further, suitable locking means must be provided having sufficient gripping to maintain the passive support 20 at the desired location during operation. In the illustrated embodiment, suitable nut, bolt and gripping washer combinations may be selected such that the passive support 20 may be manually adjusted by loosening the bolts, positioning the support and tightening the bolts. In an alternative arrangement, instead of using a slot, a series of corresponding holes in the front and rear end walls 22, 24 may be utilized and the fasteners 124 may be spring pins of suitable strength.

As a further alternative, the position of the passive support 20 in FIG. 14 may be adjusted and locked through the use of a hydraulic cylinder or electric actuator providing for ease of adjustment of the passive support 20, including possible “on the go” adjustment as a bale is disintegrated. In a preferred embodiment, hydraulic cylinders are used to control the position of the extension bars 46 (see FIG. 7). Similarly, hydraulic cylinders may be used to control the position of the passive support 20 and these may be plumbed together with the hydraulic cylinders for the extension bars 46 to provide for coordinated movement of the extension bars 46 and the passive support 20 during disintegration of the bale. Alternatively, of course, the position of the passive support 20 and extension bars 46 may be separately controlled.

As will be apparent to a person of ordinary skill in the art, the placement (position relative to the flail roller 14 and angle relative to the horizontal) and orientation of the passive support 20 affects the efficiency of processing of bales. Care should be taken to place the passive support 20 such that the creation of a pinch point is avoided between the flail guard rods 30 and the passive support 20 where separated material may be out of reach of the flails 19. Additionally, the passive support 20 may be placed closer to, or further away from, the pre-disintegrator roller 16 to adjust the size of the disintegration zone therebetween. In some cases, the application for which the processor is intended may facilitate a relatively small opening between the pre-disintegrator roller 16 and the passive support 20, in which case no flail guard rods may be required. With respect to the height of the passive support 20, the Applicant has found that placing the passive support 20 at a height above the flail roller 14 generally equivalent to a height above the flail roller 14 at which the pre-disintegrator roller 16 is mounted is preferred.

As will also be apparent to a person of ordinary skill in the art, structural elements of the bale processor 10 are to be made of suitable material having sufficient strength for the purpose intended.

Modifications of the described embodiments will be understood by those skilled in the art to be within the ambit of the following claims.

1. A bale processor comprising:
a processing chamber;
a roller with bale engaging members attached thereto, said roller being rotatably mounted in said processing chamber about a first longitudinal axis;
a pre-disintegrator roller mounted for rotation about a second longitudinal axis above, and generally parallel to, said first longitudinal axis and to a first side of said roller; and
a passive bale support mounted so as to define a plane extending away from said roller at an angle of greater than approximately 25 degrees to the horizontal from a lowest support point generally adjacent to the outer extension of said bale engaging members, said passive bale support being located to a second side of said roller such that a bale in the processing chamber is supported against downward movement on the second side of said roller substantially wholly by said passive bale support such that the bale is supported without a driven roller on the second side
wherein said pre-disintegrator roller and said passive bale support facilitate maintenance of a bale above said roller for engagement of said bale by said roller between said pre-disintegrator roller and said passive bale support.

2. The bale processor of claim 1 wherein said passive bale support is mounted at a height above said roller generally equivalent to the height above said roller at which said pre-disintegrator is mounted.

3. The bale processor of claim 1 wherein said angle of said passive support is approximately 35 degrees.

4. The bale processor of claim 1 wherein the position of the passive support in the processor is adjustable.

5. The bale processor of claim 1 wherein said pre-disintegrator roller includes separating members adapted to separate crop material from said bale during operation of said bale processor.

6. The bale processor of claim 5 wherein said separating members are further adapted to rotate said bale to expose different portions of said bale to said roller.

7. The bale processor of claim 6 wherein said separating members comprise a first plurality of teeth.

8. The bale processor of claim 7 wherein said first plurality of teeth are formed as plate-like elements configured to flatten from a v-shaped base edge to a linear top edge.

9. The bale processor of claim 8 further comprising a cross bar connected between selected ones of said first plurality of teeth.

10. The bale processor of claim 8 wherein said pre-disintegrator roller includes a second plurality of teeth that are flat, trapezoidal members mounted to said pre-disintegrator roller at an angle to said second longitudinal axis.

11. The bale processor of claim 1 wherein said processing chamber includes an extension member mounted between a front end wall of said processing chamber and a back end wall of said processing chamber on said second side of said roller and wherein said extension member extends said processing chamber generally along said plane defined by said passive bale support.

12. The bale processor of claim 11 wherein said extension member is pivotable to a closed position in which said extension member overlays said roller.

13. The bale processor of claim 12 further comprising an actuator operable to pivot said extension member during operation of said bale processor.

14. The bale processor of claim 1 wherein said passive bale support comprises a series of passive rollers defining said plane.

15. The bale processor of claim 1 further comprising guard rods mounted transverse to and spaced along said first longitudinal axis and mounted at a height above said roller to allow said bale engaging members to extend between and beyond said guard rods to engage said bale when said bale processor is in operation.

16. The bale processor of claim 15 wherein said guard rods are shaped to allow for a degree of extension of said bale engaging members beyond said guard rods that increases as said bale engaging members rotate through a portion of the length of said guard rods.

17. The bale processor of claim 16 wherein the position of said guard rods is adjustable to alter said degree of extension.

18. The bale processor of claim 16 wherein said guard rods cantilever from a guard rod mounting bar mounted within said processing chamber.

19. The bale processor of claim 1 wherein said processing chamber is configured such that a distance exists between said pre-disintegrator roller and a side wall of said processing chamber closest to said pre-disintegrator roller, where said distance is sufficient to allow passage of some material separated from said bale.

20. The bale processor of claim 1 wherein said pre-disintegrator roller is fixed to a front end wall of said processing chamber and a back end wall of said processing chamber.

21. The bale processor of claim 1 wherein said pre-disintegrator roller is mounted to a front end wall of said processing chamber and a back end wall of said processing chamber such that a distance between said pre-disintegrator roller and said roller is adjustable.

22. The bale processor of claim 1 wherein said pre-disintegrator roller is mounted to a front end wall of said processing chamber and a back end wall of said processing chamber such that a distance between said pre-disintegrator roller and said roller may change throughout processing within a predetermined range.

23. The bale processor of claim 1 wherein said bale engaging members are flails pivotally mounted on said roller.

24. A bale processor comprising:
a processing chamber;
a roller with bale engaging members attached thereto, said roller being rotatably mounted in said processing chamber about a first longitudinal axis;
a pre-disintegrator roller for rotation about a second longitudinal axis above, and generally parallel to, said first longitudinal axis and to a first side of said roller, said pre-disintegrator roller including a plurality of separating members and a plurality of manipulating members;
guard rods mounted transverse to and spaced along said first longitudinal axis and mounted at a height above said roller to allow said bale engaging members to extend between and beyond said guard rods to engage a bale when said bale processor is in operation; and
a passive bale support mounted so as to define a plane extending away from said roller at an angle of greater than approximately 25 degrees to the horizontal from a lowest support point generally adjacent to the outer extension of said bale engaging members and above said roller, said passive bale support being located to a second side of said roller such that a bale in the processing chamber is supported against downward movement on the second side of said roller substantially wholly by said passive bale support such that the bale is supported without a driven roller on the second side.
wherein said pre-disintegrator roller and said passive bale support facilitate maintenance of said bale above said roller for engagement of said bale by said roller between said pre-disintegrator roller and said passive bale support.

25. A bale processor comprising:
a processing chamber;
a roller with bale engaging members attached thereto, said roller being rotatably mounted in said processing chamber about a first longitudinal axis;
a pre-disintegrator roller for rotation about a second longitudinal axis above, and generally parallel to, said first longitudinal axis and to a first side of said roller, said pre-disintegrator roller including a plurality of separating members and a plurality of manipulating members;
guard rods mounted transverse to and spaced along said first longitudinal axis and mounted at a height above said roller to allow said bale engaging members to extend between and beyond said guard rods to engage a bale when said bale processor is in operation;
a passive bale support mounted so as to define a plane extending away from said roller at an angle of greater than approximately 25 degrees to the horizontal from a lowest support point generally adjacent to the outer extension of said bale engaging members and above said roller, said passive bale support being located to a second side of said roller such that a bale in the processing chamber is supported against downward movement on the second side of said roller substantially wholly by said passive bale support such that the bale is supported without a driven roller on the second side.
wherein said pre-disintegrator roller and said passive bale support facilitate maintenance of said bale above said roller for engagement of said bale by said roller between said pre-disintegrator roller and said passive bale support; and
wherein said processing chamber includes an extension member pivotally mounted between a front end wall of said processing chamber and a back end wall of said processing chamber to said second side of said roller, said active extension member being pivotable between an open position in which said active extension member extends along said plane of said passive bale support and a closed position in which said extension member overlays said roller.
